(19) United States
(12) Patent Application Publication
(10) Pub. No.: US 2025/0121488 A1
(43) Pub. Date: Apr. 17, 2025

(54) ITEM COLLECTION DEVICES, WIRE FRAME ASSEMBLIES, AND METHODS OF ASSEMBLING WIRE FRAMES

(71) Applicant: George A Palmer LTD, Peckleton (GB)

(72) Inventor: Michael Robert Needham Palmer, Peckleton (GB)

(21) Appl. No.: 18/486,517

(22) Filed: Oct. 13, 2023

(51) Int. Cl. B25J 1/02

(52) U.S. Cl. CPC B25J 1/02

(57) ABSTRACT

An item collection device includes a handle and a wire frame assembly coupled to the handle, the wire frame assembly having a plurality of wires forming a basket-like structure. An arm member including a protrusion positioned on the distal end of the arm member is hingedly coupled to the handle and is rotatable between a collection position and a release position. When the arm member is rotated to the release position, the protrusion extends between the plurality of wires to form an opening in the wire frame assembly.

### TECHNICAL FIELD

The present specification generally relates to item collection devices, and more specifically, to replaceable wire frame assemblies for item collection devices.

### BACKGROUND

Traditional item collection devices provide a convenient and efficient way to gather and retrieve items, such as sports balls (e.g., golf, tennis, baseball, etc.). Oftentimes, these devices may utilize tension-based systems for collection, in which a series of wires are stretched and held in place via various wire retention systems. While these item collection devices may be effective initially, repeated stretching and contraction of the wires can lead to wire fatigue and failure, resulting in the need to replace wires to continue use of the device. However, the wire retention systems implemented in traditional item collection devices are typically complex and cumbersome to assemble, making maintenance and replacement of wires a challenge. Accordingly, a need exists for an item collection device having a wire retention system that allows for quick and easy replacement of wires.

### SUMMARY

In an embodiment, an item collection device is disclosed. The item collection device includes a handle and a wire frame assembly coupled to the handle, the wire frame assembly having a plurality of wires forming a basket-like structure. An arm member including a protrusion positioned on the distal end of the arm member is hingedly coupled to the handle and is rotatable between a collection position and a release position. When the arm member is rotated to the release position, the protrusion extends between the plurality of wires to form an opening in the wire frame assembly.

In another embodiment, a wire frame assembly is disclosed. The wire frame assembly includes an inner hub having at least one recess and an outer hub coupled to the inner hub, with the outer hub further including an alignment slot. At least one wire including at least one end having a non-linear profile is disposed within the at least one recess of the inner hub. The outer hub is rotatable relative to the inner hub between an unlocked position and a locked position, such that, in the unlocked position, the alignment slot aligns with the at least one recess and the at least one end of the at least one wire is positioned within the at least one recess, and in the locked position, the outer hub is rotated such that the alignment slot is misaligned with the at least one recess.

In yet another embodiment, a method of assembling a wire frame assembly is disclosed. The method includes rotatably coupling an inner hub having a plurality of recesses to an outer hub having an alignment slot; aligning the alignment slot of the outer hub with at least one of the plurality of recesses; inserting an end of a wire into the at least one of the plurality of recesses in alignment with the alignment slot, the end of the wire including a non-linear profile; and rotating the outer hub relative to the inner hub such that the alignment slot becomes misaligned with the at least one of the plurality of recesses that receives the end of the wire and the wire becomes locked between the inner hub and the outer hub.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a front-side view of an item collection device, according to one or more embodiments shown and described herein;

FIG. 2 depicts a side-view of the item collection device of FIG. 1, according to one or more embodiments shown and described herein;

FIG. 3 depicts a perspective view of a wire frame assembly of the item collection device of FIGS. 1 and 2, according to one or more embodiments shown and described herein;

FIG. 4 depicts a front-side view of the wire frame assembly of FIG. 3, according to one or more embodiments shown and described herein;

FIG. 5 depicts a cross-sectional view of the wire frame assembly of FIG. 4 along line 5-5, according to one or more embodiments shown and described herein;

FIG. 6A depicts a perspective view of an inner hub of the wire frame assembly of FIG. 4, according to one or more embodiments shown and described herein;

FIG. 6B depicts a top-side view of the inner hub of FIG. 6A, according to one or more embodiments shown and described herein;

FIG. 6C depicts a side-view of the inner hub of FIGS. 6A and 6B, according to one or more embodiments shown and described herein;

FIG. 7A depicts a perspective view of an outer hub of the wire frame assembly of FIG. 4, according to one or more embodiments shown and described herein;

FIG. 7B depicts a side view of the outer hub of FIG. 7A, according to one or more embodiments shown and described herein;

FIG. 8 depicts a front-side view of a wire of the wire frame assembly of FIG. 4, according to one or more embodiments shown and described herein;

FIG. 9 depicts a perspective view of a hub cap of the wire frame assembly of FIG. 4, according to one or more embodiments shown and described herein;

FIG. 10 depicts a perspective view of a flange of the wire frame assembly of FIG. 4, according to one or more embodiments shown and described herein; and

FIG. 11 depicts an illustrative flow diagram of a method of assembling a wire frame assembly, according to one or more embodiments shown and described herein.

### DETAILED DESCRIPTION

Embodiments disclosed herein relate to item collection devices, wire frame assemblies, and methods of assembling wire frames. More specifically, the present disclosure relates to an item collection device including a handle and a wire frame assembly attached to the handle, the wire frame assembly including a plurality of wires forming a basket-like structure. An arm member is hingedly coupled to the handle and is rotatable between a collection position and a release position, and further includes a protrusion that extends between the plurality of wires to form an opening in the wire frame assembly when the arm member is moved to the release position.

In these embodiments, the wire frame assembly may further include an inner hub having at least one recess and an outer hub having an alignment slot. The alignment slot may be aligned with the at least one recess of the inner hub, such that at least one of the plurality of wires may be inserted through the alignment slot and into the at least one recess. Once the wire is positioned within the at least one recess, the outer hub may be rotated relative to the inner hub, such that the alignment slot rotates over the wire and causes the wire to deform. The deformation of the wire caused by rotation of the outer hub may act to lock the wire between the outer hub and the inner hub. Additional wires may be inserted and locked between the inner hub and the outer hub in a similar manner until each of the plurality of wires have been secured in the wire frame assembly. The disclosed item collection device and wire frame assembly allows for any of the plurality of wires to be replaced by simply rotating the outer hub relative to the inner hub and removing a damaged and/or worn wire from the assembly.

As should be appreciated, traditional item collection devices, which may often be used in sports like tennis, golf, and baseball, provide a convenient way to gather and store items during practice or after play. Traditional wire frame assemblies used in these devices tend to involve simplistic clamping or press-fit mechanisms, which over time can lead to wear and tear. Frequent use of these devices can result in the wires loosening, bending, or even breaking, reducing their efficiency and lifespan.

Furthermore, existing wire frame assemblies utilized in item collection devices may rely on tension-based systems to secure the wires, in which the wires are stretched and held in place by inherent tension or additional clamps. While initially effective, repeated stretching and relaxation of the wires can lead to fatigue, thereby reducing the resilience of the wire and its ability to maintain tension. Other wire assembly systems may utilize a snap-fit or groove mechanism which can be cumbersome to assemble and are prone to misalignment or damage under heavy loads.

Furthermore, it should be appreciated that the more complex the wire locking mechanism, the harder and more time-consuming it is to replace or repair individual wires, making maintenance a challenge.

The disclosed item collection device and wire frame assembly address these shortcomings by providing a device that is resistant to wear and is also user-friendly, thereby allowing for easy assembly, maintenance, and potential wire replacements. In particular, the interaction between the non-linear ends of the wires and the hub member allows the wires to be secured within the hub member simply be rotating an outer hub component relative to an inner hub component. This design facilitates straightforward assembly, allowing wires to be inserted systematically and locked in place with a simple rotation of the outer hub, while also making it easier to replace or adjust individual wires if needed. Furthermore, the non-linear profile of the ends of the wires may aid in reducing the repetitive strain on any single point of the wire. For example, the wire configuration described herein may allow for more even load distribution across the wire, which may aid in reducing the chances of metal fatigue or breakage. Accordingly, the item collection device and wire frame assembly described herein may offer a more reliable, durable, and efficient product than their traditional counterparts.

Embodiments of item collection devices, wire frame assemblies, and methods of assembling wire frame assemblies will now be described in additional detail herein. The following will now describe these item collection devices, wire frame assemblies, and methods in more detail with reference to the drawings and where like numbers refer to like structures.

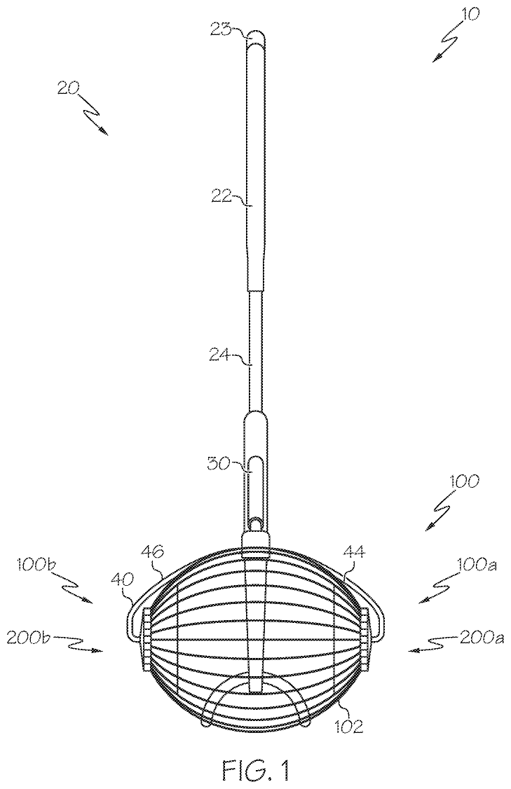

Referring now to FIGS. 1-3, an item collection device 10 for collecting a variety of items is depicted. The item collection device 10 may include a handle 20, an arm member 30, and a connector 40 that releasably couples a wire frame assembly 100 to the handle 20. In these embodiments, the wire frame assembly 100 may be configured to rotate about the connector 40, such that contact between the wire frame assembly 100 and an item as the wire frame assembly 100 rotates causes the item to be secured within the wire frame assembly 100, as will be described in additional detail herein.

Referring still to FIGS. 1-3, the handle 20 may include a proximal handle portion 22 and a distal handle portion 24, with the proximal handle portion 22 being configured to be engaged by a user to push the item collection device 10 along a surface (e.g., flooring, outside environment, sports court, etc.) and collect items. In these embodiments, the proximal handle portion 22 of the handle 20 may be ergonomically designed to aid in collection of items and enhance user comfort. For example, the proximal handle portion 22 may include a contoured grip 23 that may be designed to conform to a shape of a user's hand. By conforming the contoured grip 23 to the user, it may be possible to reduce strain on the user as the item collection device 10 is used.

Although not depicted, it should be further appreciated that a variety of other ergonomic design features may be implemented in the proximal handle portion 22 in order to increase user comfort and aid in the collection of items. For example, the proximal handle portion 22 may be formed of a soft grip material, such as soft rubber, silicon, foam, or any similar material providing a comfortable and non-slip grip. Furthermore, in some embodiments, the proximal handle portion 22 may be adjustable in length, such that the item collection device 10 is able to accommodate users of varying heights. In other embodiments still, the proximal handle portion 22 may also include a thumb and/or wrist rest and/or cushion, which may be used to provide additional comfort and/or control when pushing and/or maneuvering the item collection device 10.

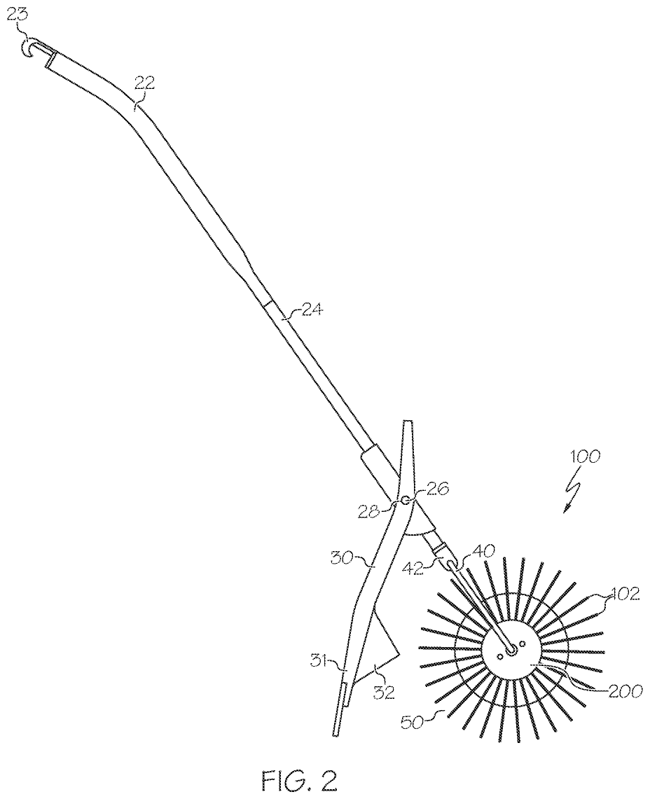

Referring still to FIGS. 1-3, the distal handle portion 24 may be configured to receive both the arm member 30 and connector 40. For example, as most clearly depicted in FIG. 2, the distal handle portion 24 may include an arm member port 26 configured to couple the arm member 30 to the distal handle portion 24. In these embodiments, a fastener 28 may extend through the arm member 30 and the arm member port 26 formed on the distal handle portion 24, such that the arm member 30 may be hingedly and/or rotatably coupled to the distal handle portion 24 of the handle. It should be appreciated that the fastener 28 may include a pin (e.g., cotter pin, dowel pin, spring pin), screw, bolt, or any other similar fastener that allows the arm member 30 to pivot relative the distal handle portion 24.

As further depicted in FIGS. 1-3, the arm member 30 may further include a protrusion 32 positioned on a distal end 31 of the arm member 30. In these embodiments, as the arm member 30 pivots, the protrusion 32 may extend into the wire frame assembly 100, such that an opening 50 is formed in the wire frame assembly 100 for releasing any items collected in the wire frame assembly 100. For example, in the embodiments described herein, the arm member 30 may be pivotable and/or rotatable between a collection position and a release position. In the collection position, the arm member 30 may be positioned such that the protrusion 32 does not interfere with the wire frame assembly 100, thereby allowing the wire frame assembly 100 to collect items as it is maneuvered. Once the wire frame assembly 100 is full, or has collected all desired items, the arm member 30 may be pivoted to the release position, such that the protrusion 32 extends into the wire frame assembly 100 and forms the opening 50. With the opening 50 formed in the wire frame assembly 100, items may be removed from the wire frame assembly 100. Operation of the arm member 30 and wire frame assembly 100 will be described in additional detail herein.

It should be further appreciated that, although the protrusion 32 is depicted as being a conical member, the protrusion 32 may take any shape and/or form capable of creating an opening within the wire frame assembly 100. For example, in some embodiments, the protrusion 32 may include a barbed or toothed surface for engaging the wire frame assembly 100, while in other embodiments, the protrusion 32 may include a ball end, a forked end, or a split end. In further embodiments still, the protrusion 32 may include a tapered end or surface, such that the size of the opening 50 may be adjusted based on the degree to which the protrusion 32 is inserted into the wire frame assembly 100.

Furthermore, in some embodiments, the protrusion 32 may be positioned at different locations on the arm member 30 based on the size of the basket-like structure formed by the plurality of wires 102. For example, in embodiments in which the plurality of wires 102 form a relatively smaller basket-like structure (e.g., for collecting nuts, fruits, etc. as opposed to sports balls), the protrusion 32 may be positioned away from the distal end 31 of the arm member 30 in order to ensure that the protrusion 32 forms the opening 50 in the wire frame assembly 100 at a desired position. Accordingly, it should be appreciated that the position of the protrusion 32 on the arm member 30 may be adjusted based on the size of the basket-like structure formed by the plurality of wires 102 of the wire frame assembly 100.

Referring still to FIGS. 1-3, and as has been described herein, the distal handle portion 24 may be further configured to couple with the connector 40. In these embodiments, the connector 40 may include a handle adapter 42, which may be configured to be received by the distal handle portion 24. For example, in these embodiments, the handle adapter 42 may include a threaded surface configured to be screwed into the distal handle portion 24. In other embodiments, the handle adapter may include a spring-loaded mechanism, such as a spring-loaded pin, that may be configured to be received by a port and/or notch formed within the distal handle portion 24. For example, in these embodiments, the spring-loaded mechanism may be depressed such that the handle adapter 42 may be inserted into the distal handle portion 24. Once the handle adapter 42 is inserted, the spring-loaded mechanism may be released, such that the spring-loaded mechanism extends into and/or through the notch and/or port formed in the distal handle portion 24 to secure the connector 40 to the handle 20.

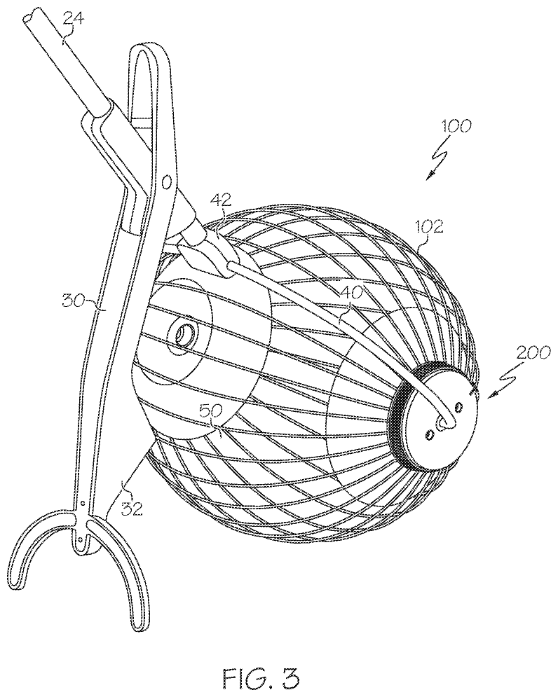

As further depicted in FIGS. 1-3, the connector 40 may be further configured to couple the wire frame assembly 100 to the handle 20. In these embodiments, the connector 40 may include a plurality of brackets, such as a first bracket 44 and a second bracket 46, which may be configured to couple to the wire frame assembly 100. For example, as depicted most clearly in FIGS. 1 and 3, the first bracket 44 and the second bracket 46 may extend at least partially around a perimeter of the wire frame assembly 100, such that the first bracket 44 interfaces with a first end portion 100a of the wire frame assembly 100 and the second bracket 46 interfaces with a second end portion 100b of the wire frame assembly 100. In these embodiments, the first bracket 44 and the second bracket 46 may be rotatably coupled to the first end portion 100a and the second end portion 100b of the wire frame assembly, respectively, such that the first bracket 44 and the second bracket 46 prevent the wire frame assembly 100 from moving in a longitudinal direction (e.g., +/−x-direction as depicted in the coordinate axes of FIGS. 1-3) and/or lateral direction (e.g., +/−y-direction as depicted in the coordinate axes of FIGS. 1-3) while allowing the wire frame assembly 100 to rotate relative the first bracket 44 and the second bracket 46, respectively.

Referring still to FIGS. 1-3, the first bracket 44 and second bracket 46 may be curved, such that the first bracket 44 and the second bracket 46 form a generally U-shaped profile. By utilizing curved brackets, it may be possible to ensure that the first bracket 44 and the second bracket 46 do not interfere with the plurality of wires 102 positioned within the wire frame assembly 100 as the wire frame assembly 100 rotates during use. Although the first and second brackets 44, 46 are depicted as being curved brackets, it should be appreciated that the brackets may take any shape (e.g., L-brackets, etc.) that allow the wire frame assembly 100 to rotate without interference during use.

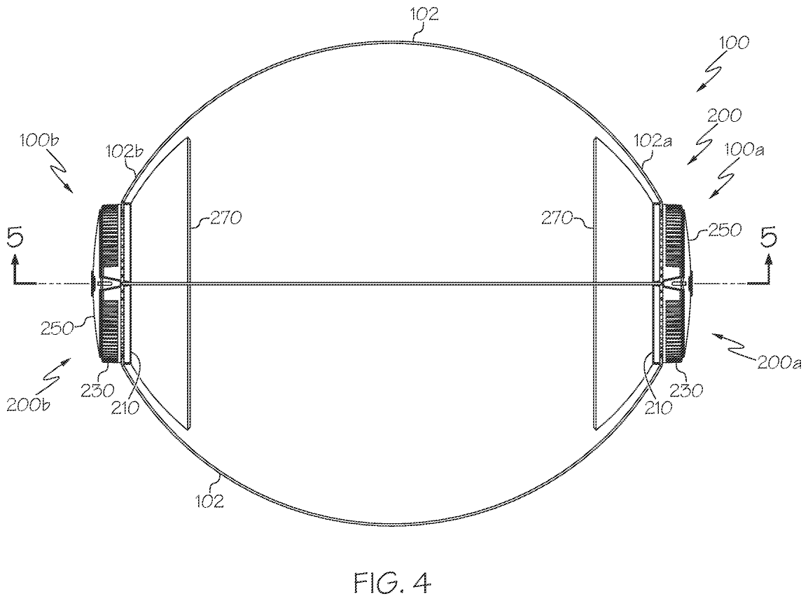

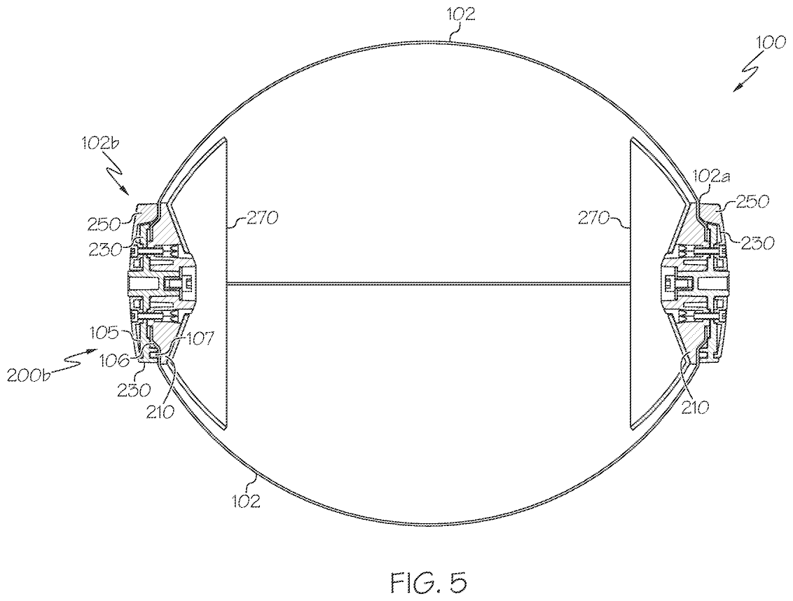

Referring now to FIGS. 4-9, the wire frame assembly 100 is depicted in additional detail. As depicted most clearly in FIGS. 4 and 5, the first end portion 100a and the second end portion 100b may each include a hub member 200, with the hub member 200 being configured to interface with the connector 40 of the item collection device 10 and the plurality of wires 102 that form the cage-like structure used to collect various items during operation, as will be described herein.

In these embodiments, the hub member 200 may include an inner hub 210, an outer hub 230, a hub cap 250, and a flange 270 which may interface with one another to secure the plurality of wires 102 within the hub member 200 an ensure that the plurality of wires 102 maintain a desired shape and/or structure during use of the item collection device 10. The hub member 200 may be configured to allow for the removal and/or replacement of any number of the plurality of wires 102, as will be described in additional detail herein.

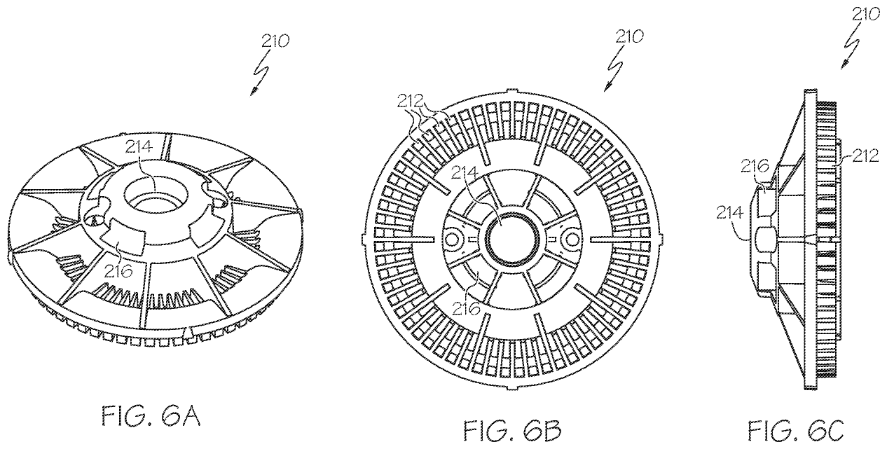

Referring now to FIGS. 4-6C, the inner hub 210 of the hub member 200 will be described in additional detail. As depicted most clearly in FIGS. 6A-6C, the inner hub 210 may include a plurality of recesses 212, which may be configured to receive at least one end of each of the plurality of wires 102 that form the basket-like structure of the wire frame assembly 100. In these embodiments, the plurality of recesses 212 may be positioned equidistantly around a circumference of the inner hub 210, such that, when each of the plurality of recesses 212 receives one of the plurality of wires 102, the plurality of wires 102 are similarly equidistantly spaced about the circumference of the inner hub 210. It should be appreciated that, in these embodiments, the equidistant spacing of the plurality of recesses 212, and in turn, the plurality of wires 102 about the inner hub 210 may aid in the collection of items during operation of the item collection device 10, as equal spacing may exist between each of the plurality of wires 102.

Although the inner hub 210 is depicted as having a plurality of recesses 212 that are spaced in an equidistant manner about the circumference of the inner hub 210, it should be understood that, in other embodiments, the plurality of recesses 212 may be variably spaced about the inner hub 210. For example, in some embodiments, varying the spacing of the plurality of recess 212, and in turn, the plurality of wires 102 may aid in the collection of irregularly shaped objects. Furthermore, it should be appreciated that, in some embodiments, each of the plurality of recess 212 formed in the inner hub 210 may not receive at least one of the plurality of wires 102. In these embodiments, a user may select which of the plurality of recesses 212 receive at least one of the plurality of wires 102, such that the user may alter the structure of the wire frame assembly 100 and/or the gap that exists between each of the plurality of wires 102 in order to accommodate the collection of objects having varying shapes and sizes.

Referring still to FIGS. 4-7B, the inner hub 210 may further include a central opening 214 which is configured to receive a shaft 232 that extends from the outer hub 230. In these embodiments, the shaft 232 of the outer hub 230 may be received within the central opening 214 of the inner hub 210 such that the outer hub 230 is capable of rotating relative to and/or about the inner hub 210.

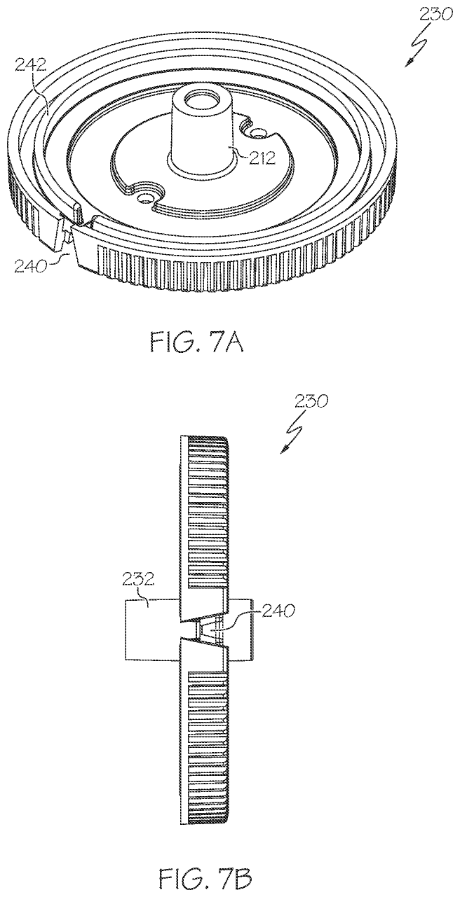

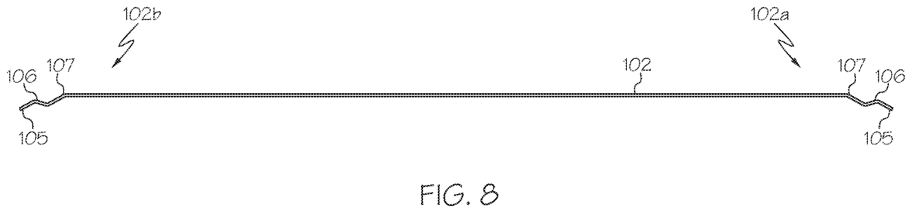

As depicted most clearly in FIGS. 7A and 7B, the outer hub 230 may further include an alignment slot 240, which may be configured to align with and provide a clearance for each of the plurality of recesses 212 formed in the inner hub 210. For example, the outer hub 230 may be rotated such that the alignment slot 240 may be brought into alignment with any of the plurality of recesses 212 formed in the inner hub 210. In these embodiments, when the alignment slot 240 is aligned with one of the plurality of recesses 212, an end of one of the plurality of wires 102 may be inserted into the one of the plurality of recesses 212 which is aligned with the alignment slot 240 of the outer hub 230. In operation, the alignment slot 240 may be in alignment with a single recess of the plurality of recesses 212 at a particular time, such that the perimeter of the outer hub 230 effectively blocks any of the plurality of recesses 212 that are not in alignment with the alignment slot 240 of the outer hub 230.

Referring still to FIGS. 7A and 7B, the outer hub 230 may further include an extrusion 242 formed on an interior surface of the outer hub 230. In these embodiments, the extrusion 242 may extend in the same direction as the shaft 232 (e.g., in the +y-direction as depicted in the coordinate axis of FIG. 7A) such that, when the shaft 232 is positioned within the central opening 214 of the inner hub 210, the extrusion 242 may similarly contact and/or partially extend into the inner hub 210. In the embodiments depicted in FIGS. 7A and 7B, the extrusion 242 may have a generally circular profile, but it should be appreciated that the extrusion 242 may take any shape without departing from the scope of the present disclosure (e.g., square, rectangular, triangular, etc.).

Referring again to FIGS. 4-7B, when an end of at least one of the plurality of wires 102 is inserted through the alignment slot 240 and the recess of the plurality of recesses 212 in alignment with the alignment slot 240, at least a portion of the wire 102 may be positioned between the inner hub 210 and the outer hub 230. In these embodiments, rotation of the outer hub 230 relative the inner hub 210 may cause the extrusion 242 to contact the portion of the wire 102 positioned between the inner hub 210 and the outer hub 230 to lock the wire within the hub member 200, as will be described in additional detail herein.

Referring now to FIGS. 4-8, once an end of at least one of the wires of the plurality of wires 102 is inserted into the recess of the plurality of recesses 212 which is in alignment with the alignment slot 240 of the outer hub 230, the outer hub 230 may be rotated (e.g., either clockwise or counterclockwise) to lock the end of the at least one wire within the hub member 200. In these embodiments, the end of the at least one wire may include a non-linear profile, which may aid in securing the wire within the hub member 200, as will be described in additional detail herein.

As most clearly depicted in FIG. 8, each wire of the plurality of wires 102 may include a first end 102a and a second end 102b, with at least one of the first end 102a and the second end 102b including a non-linear profile. In the embodiments depicted in FIG. 8, each of the first end 102a and the second end 102b may include a generally zig-zag shaped profile, which allows for various portions of the first end 102a and/or second end 102b of the wire to contact different portions of the inner hub 210 and outer hub 230 when the wire is positioned, thereby increasing the deflection points of the wire within the hub member 200 and enhancing the security of the wire within the hub member 200. Furthermore, the zig-zag shaped (or “z-shaped”) profile of the first end 102a and/or second end 102b of the wire may ensure that the plurality of wires 102 do not become tangled during assembly. For example, wires having hooked, or other similarly curved ends, may become intertwined during assembly, which may cause difficulties when forming the basket-like structure of the wire frame assembly 100. Such issues may be alleviated by utilizing the zig-zag shaped wire ends depicted in FIG. 8.

For example, in the embodiment depicted in FIG. 8, the first end 102a and the second end 102b of the wire 102 may include a first portion 105, a second portion 106, and a third portion 107, each of which interface with various structures within the hub member 200. When the first end 102a and/or second end 102b are inserted into the recess of the inner hub 210 that is in alignment with the alignment slot 240 of the outer hub 230, the first portion 105 may extend through the recess 212 and into a space between the inner hub 210 and the outer hub 230. Furthermore, the second portion 106 of the first end 102a and/or second end 102b may be positioned within the recess 212, while the third portion 107 is positioned between the inner hub 210 and the outer hub 230 and within the alignment slot 240.

Referring again to FIGS. 4-8, once the wire 102 is positioned, rotation of the outer hub 230 relative the inner hub 210 may cause the end portion (e.g., first end or second end 102a, 102b) of the wire 102 to deflect. For example, rotation of the outer hub 230 may cause the alignment slot 240 to apply a force to the third portion 107 of the end of the wire, while the extrusion 242 may contact and apply a force to the first portion 105 of the end portion positioned between the inner hub 210 and the outer hub 230.

As noted herein, rotation of the outer hub 230 may cause the various portions (e.g., first portion 105, second portion 106, third portion 107) of the first and/or second end 102a, 102b to deflect and/or deform. In these embodiments, once the outer hub 230 rotates (e.g., in the clockwise or counterclockwise direction) past (e.g., over) the wire 102, the first and/or second end 102a, 102b may attempt to revert to their original, non-deflected state. However, the rotation of the outer hub 230 may cause the wire 102 to become locked between the structure of the inner hub 210 and the outer hub 230, thereby securing the wire 102 within the hub member 200.

It should be further appreciated that, although the first end 102a and the second end 102b of the plurality of wires are depicted as having generally symmetrical zig-zag profiles (e.g., each portion being of equal length and positioned at equal and/or opposite angles), the profile of the first end 102a and the second end 102b of each of the plurality of wires 102 may be altered to impact the deflection of the wire 102 when the outer hub 230 is rotated, and in turn, the strength of the coupling between the wire 102 and the hub member 200. For example, utilizing a wire end having deeper and/or more pronounced portions may increase the strength of the coupling between the wire 102 and the hub member 200 by increasing interference between the components of the hub member 200 and the wire 102. However, it should be noted that increasing interference between wire 102 and the hub member 200 may increase the force required to rotate the outer hub 230 relative the inner hub 210. Accordingly, in some embodiments, a wire end having shallow and/or less pronounced end portions may allow for the outer hub 230 to be rotated more easily, thereby simplifying assembly of the wire frame assembly 100.

Furthermore, it should be understood that the plurality of wires 102 may have any non-linearly shaped profile without departing from the scope of the present disclosure. For example, the first and/or second end 102a, 102b of each of the plurality of wires 102 may include a serrate and/or toothed profile (e.g., a profile having more pronounced and/or varied peaks and troughs than that illustrated in FIG. 8), a curved and/or wavy profile, or a spiked and/or barbed profile. In these embodiments, it may be further possible to alter the shape and/or structure of the inner hub 210 and/or outer hub 230 to accommodate varying wire profiles, if necessary.

Referring still to FIGS. 4-8, in these embodiments, the process of inserting at least one of the plurality of wires 102 into a recess of the inner hub 210 and rotating the outer hub 230 to secure the wire within the hub member 200 may be repeated until each of the plurality of wires 102 has been inserted into the hub member 200. For example, in some embodiments, the number of the plurality of wires 102 may correspond to the number of the plurality of recesses 212 of the inner hub 210, such that one of the plurality of wires 102 is inserted into each of the plurality of recesses. However, it should be appreciate that, in some embodiments, the number of the plurality of wires 102 may be less than the number of the plurality of recesses 212, such that at least one of the plurality of recesses 212 does not receive a wire.

In the embodiments described herein, it should be further noted that rotation of the outer hub 230 may be further utilized to release the plurality of wires 102 from the hub member 200. For example, the alignment slot 240 of the outer hub 230 may be moved from a locked position to an unlocked position with respect to each of the plurality of recesses 212 formed within the inner hub 210. In these embodiments, when the alignment slot 240 is aligned with a particular recess of the plurality of recesses 212, the particular recess may be considered to be in the unlocked position, in which a wire may be inserted into the recess or removed from the recess. Accordingly, in the event a wire positioned within the hub member 202 is damaged and/or requires replacement, the individual wire may be removed from the hub member 200 by aligning the alignment slot 240 of the outer hub 230 with the recess in which the wire is inserted, at which point the wire may be pulled from the hub member 200 by a user. Once the damaged wire is removed, a replacement wire may be inserted into the recess and the outer hub 230 may be rotated such that the alignment slot 240 translates over and/or past the recess, thereby moving the outer hub 230 to the locked position with respect to the particular recess.

Referring now to FIGS. 4-9, the hub member 200 of the wire frame assembly 100 may further include a hub cap 250, which may be coupled to the outer hub 230 of the hub member 200 once each of and/or a desired number of the plurality of wires 102 have been secured within the hub member 200. In these embodiments, the hub cap 250 may prevent the outer hub 230 from rotating relative the inner hub 210 as the wire frame assembly 100 rotates, thereby ensuring that the plurality of wires 102 may not become disconnected and/or dislodged during operation of the item collection device.

Referring still to FIGS. 4-9, the hub cap 250 may include a connector opening 252, which may be configured to receive either the first bracket 44 or second bracket 46 of the connector 40 to couple the wire frame assembly 100 to the handle 20 of the item collection device 10. As has been described herein in detail with reference to FIGS. 1 and 3, the connector opening 252 may allow for the wire frame assembly 100 to be rotatably coupled to the handle 20, such that the basket-like structure formed by the plurality of wires 102 may rotate and collect items during operation of the item collection device 10.

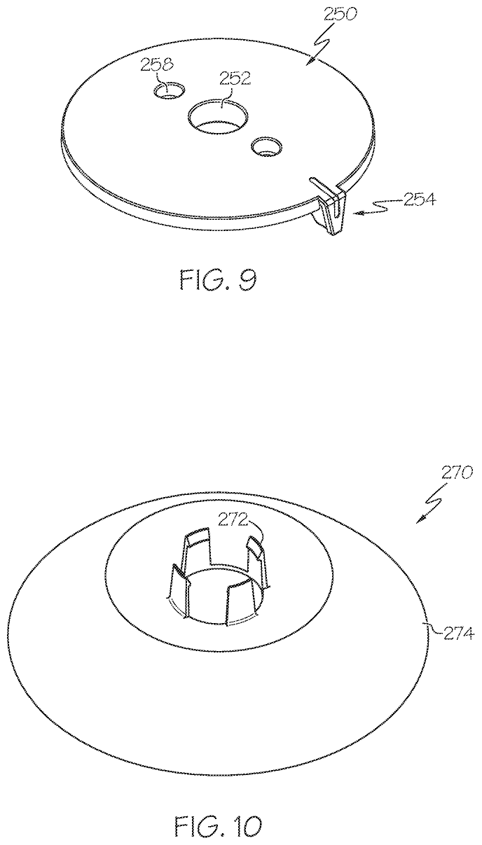

As is most clearly depicted in FIG. 9, the hub cap 250 may further include a projection 254 extending from an inner surface of the hub cap 250. In these embodiments, the projection 254 may be configured to be received by the alignment slot 240 of the outer hub 230. For example, as depicted in FIG. 9, the projection 254 has a generally v-shaped profile that corresponds to the shape of the alignment slot 240. Accordingly, when the hub cap is coupled to the outer hub 230, the projection 254 may fill the alignment slot 240. Although the projection 254 is depicted as being generally v-shaped, it should be appreciated that the projection 254 may take any shape corresponding to the shape of the alignment slot 240 without departing from the scope of the present disclosure.

In these embodiments, the insertion of the projection 254 into the alignment slot 240 may ensure that the plurality of wires 102 may not become disconnected during operation of the item collection device 10. As has been described herein, in order to remove one of the plurality of wires 102 from the hub member 200, the alignment slot 240 of the outer hub 230 may be aligned with the recess in which the wire is inserted. However, by coupling the hub cap 250 to the outer hub 230 such that the projection 254 extends into the alignment slot 240, the plurality of recesses 212 of the inner hub 210 may remain blocked throughout operation of the item collection device 10.

Referring still to FIGS. 4-9, the hub cap 250 may further include at least one hub opening 258, such as a pair of hub openings 258a, 258b, which may be aligned with similar hub openings formed in the inner hub 210 and outer hub 230 when the hub cap 250 is coupled to the outer hub 230. In these embodiments, a pin, or any other similar fastener capable of fixedly coupling the hub cap 250 to the outer hub 230 may be inserted through the hub opening 258 to secure the hub cap 250. As most clearly depicted in FIG. 4, in these embodiments, the pin may extend at least partially through the hub cap 250, the outer hub 230, and the inner hub 210, such that the hub cap 250, outer hub 230, and inner hub 210 are fixedly coupled together when the pin is inserted through the hub opening 258.

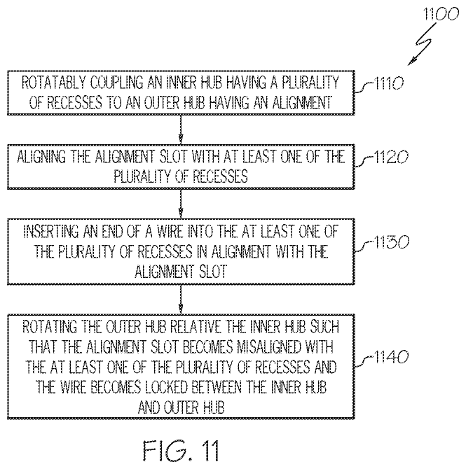

Referring now to FIGS. 4-10, the hub member 200 may further include a flange 270, which may be coupled to an outer surface of the inner hub 210. As depicted most clearly in FIG. 10, the flange 270 may include a plurality of connecting members 272 that extend outwardly from a body 274 of the flange 270. In these embodiments, the plurality of connecting members 272 may be received within a plurality of cavities 216 formed within the inner hub 210, such that the flange 270 is fixedly coupled to the inner hub 210.

As further depicted in FIG. 10, the body 274 of the flange 270 may have a curved and/or tapered surface. In these embodiments, the surface contour and/or taper of the body 274 of the flange 270 may aid in maintaining the shape and/or form of the plurality of wires 102 that form the basket-like structure of the wire frame assembly 100. For example, in the embodiments described herein, the plurality of wires 102 may conform to the shape of the body 274 of the flange 270, which may provide the wire frame assembly 100 with a spherical or elliptical shape. The flange 270 may further ensure that the plurality of wires 102 maintain a desired shape as the plurality of wires 102 are compressed (e.g., when the plurality of wires 102 contact an item and/or are rolled across a surface).

Operation and assembly of the item collection device 10 will now be described in detail with reference to FIGS. 1-10. As described herein, the first end 102a and the second end 102b of the wire frame assembly 100 may each include a hub member 200, such as a first hub member 200a and a second hub member 200b. It should be appreciated that, in these embodiments, the first hub member 200a and the second hub member 200b may be similar in structure. Accordingly, like references will be used to describe like components where possible.

Referring still to FIGS. 1-10, the outer hub 230 of the first hub member 200a may be coupled to the inner hub 210 of the first hub member 200a, such that the shaft 232 is received by the central opening 214 of the inner hub 210 and the outer hub 230 is rotatably secured to the inner hub 210. With the outer hub 230 secured to the inner hub 210, the alignment slot 240 of the outer hub 230 may be aligned with at least one of the plurality of recesses 212 formed on the inner hub 210, and a first or second end 102a, 102b of a wire 102 having a non-linear profile may be inserted into the recess in alignment with the alignment slot 240. Once the wire 102 is positioned within the recess, the outer hub 230 may be rotated relative the inner hub 210, which may cause the wire 102 to deflect and become locked within the hub member. As the outer hub 230 rotates, the alignment slot 240 may be brought into alignment with an adjacent recess of the plurality of recesses 212, and another of the plurality of wires 102 may be inserted into the inner hub 210. This process may be repeated until each of the plurality of wires 102 (or a desired number of the plurality of wires 102) have been inserted into the hub member.

With the plurality of wires 102 secured within the hub member 200, the hub cap 250 may be fixed to the outer hub 230, as has been described herein. For example, the hub cap 250 may be secured to the outer hub 230 such that the projection 254 of the outer hub 230 extends into the alignment slot 240 of the outer hub 230. Once the hub cap 250 is positioned, at least one pin, or any other similar fastener, may be inserted through the at least one hub opening 258 and at least partially through the outer hub 230 and the inner hub 210 to fix the hub cap 250, the outer hub 230, and the inner hub 210, thereby restricting further rotation between the components.

Referring still to FIGS. 1-10, the process described herein regarding the first hub member 200a may be repeated on the second hub member 200b. That is, the outer hub 230 of the second hub member 200b may be secured to the inner hub 210 of the second hub member 200, and the open ends of the plurality of wires 102 (e.g., the ends not secured within the first hub member 200a) may be secured within the second hub member 200b. With the plurality of wires 102 secured within the second hub member 200b, the hub cap 250 may be coupled to the outer hub 230 to lock the hub member 200, as has been described herein.

Once the plurality of wires 102 are secured within the first hub member 200a and the second hub member 200b, respectively, the plurality of wires 102 may form a basket-like structure. As has been described herein, the basket-like structure may have a spherical shape, an elliptical shape, or any other similar shape that may allow for the wire frame assembly 100 to rotate as it is maneuvered by a user. To maintain the structure of the plurality of wires 102, a flange 270 may be coupled to the inner hub 210 of each of the first hub member 200a and the second hub member 200b. In these embodiments, the connecting members 272 of the flange 270 may be received within a plurality of cavities 216 formed within the inner hub 210, while the body 274 of the flange 270 may ensure that the plurality of wires 102 maintain a desired shape as during operation of the item collection device 10.

With the wire frame assembly 100 assembled, the wire frame assembly 100 may be connected to the handle 20 via the connector 40 such that the item collection device 10 may be used. For example, in the embodiments described herein, the first bracket 44 of the connector may be coupled to the connector opening 252 of the hub cap 250 of the first hub member 200a, while the second bracket 46 may be coupled to the connector opening 252 of the hub cap 250 of the second hub member 200b. In these embodiments, the hub cap 250 of the first and second hub member 200a, 200b may be rotatably coupled to the first bracket and second bracket 44, 46, such that the wire frame assembly 100 may rotate (e.g., roll) relative the connector 40 when a force is applied to the item collection device 10 by a user.

Referring still to FIGS. 1-10, in operation, a user may grip the handle 20 of the item collection device 10 and push the item collection device 10 across a surface. As the user pushes the item collection device 10, the wire frame assembly 100 may rotate (e.g., roll) along the surface until the plurality of wires 102 of the wire frame assembly 100 contact an object. When an object is contacted, the object may push against the plurality of wires 102, causing the plurality of wires 102 to deform and allow the object to be received within the wire frame assembly 100. Once the object passes through the plurality of wires 102, the plurality of wires 102 contacted by the object may return to a non-deformed state, thereby securing the object within the wire frame assembly 100. As the item collection device 10 is maneuvered, the wire frame assembly 100 may collect multiple objects in quick succession, with the objects remaining secured within the wire frame assembly 100 until they are released by the user.

It should be appreciated that, in the embodiments described herein, the plurality of wires 102 may have a degree of flexibility such that objects may enter the wire frame assembly 100 and the ends (e.g., first end 102a and second end 102b) of the plurality of wires 102 may be secured within the first and second hub member 200a, 200b. Accordingly, a variety of wires having desired flexibility, durability, and resistance may be utilized in the wire frame assembly 100. For example, in these embodiments, the plurality of wires 102 may be formed of stainless steel, galvanized steel, spring steel, copper-coated steel, aluminum, polymer, nylon, carbon-fiber, or memory alloy without departing from the scope of the present disclosure.

In the embodiments described herein, it should be further appreciated that the plurality of wires 102 may have a variety of gauges (e.g., wire thicknesses). For example, the plurality of wires may include a 1.3 mm gauge, a 1.4 mm gauge, a 1.5 mm gauge, or any other similar gauge without departing from the scope of the present disclosure. In these embodiments, the gauge of each of the plurality of wires 102 may be determined based on the items being collected by the item collection device 10. For example, a larger gauge wire may be utilized in the wire frame assembly 100 to collect item that are heavier and/or more cumbersome.

Furthermore, in some embodiments, the plurality of wires 102 may be provided with a coating in order to enhance functionality and increase lifespan of the wires. For example, the plurality of wires 102 may include a rubber or elastomeric coating, anti-corrosion coating, non-stick coatings, nylon coatings, polyurethane coatings, anti-UV coatings, and/or anti-microbial coatings without departing from the scope of the present disclosure.

It should also be appreciated that the item collection device 10 described herein is not limited to the collection of balls or other similarly spherically shaped objects. For example, the item collection device described herein may be utilized for the collection of a variety of objects, including but not limited to tennis balls, golf balls, pickleballs, lacrosse balls, table tennis balls, softballs and/or baseballs, apples or oranges, walnuts or pecans, children's toys, pet toys, cricket balls, and/or plastic bottles or cans.

Turning now to FIG. 11, an illustrative flow diagram of a method 1100 of assembling a wire frame assembly is depicted. As illustrated at block 1110, the method may involve rotatably coupling an inner hub having a plurality of recesses to an outer hub having an alignment slot. The method may then involve aligning the alignment slot of the outer hub with at least one of the plurality of recesses, as shown at block 1120.

With the alignment slot aligned with at least one of the plurality of recesses, the method may advance to block 1130, which may involve inserting an end of a wire into the at least one of the plurality of recesses in alignment with the alignment slot. In these embodiments, the end of the wire may include a non-linear profile to aid in securing the wire within the recess.

As indicated at block 1140, once the end of the wire is inserted into the recess, the method may further involve rotating the outer hub relative to the inner hub such that the alignment slot becomes misaligned with the recess that has received the end of the wire. In these embodiments, rotation of the outer hub relative the inner hub may cause the wire to become locked between the inner hub and the outer hub.

As should be appreciated in view of the foregoing, item collection device is disclosed. The item collection device includes a handle and a wire frame assembly attached to the handle, the wire frame assembly including a plurality of wires forming a basket-like structure. An arm member is hingedly coupled to the handle and is rotatable between a collection position and a release position, and further includes a protrusion that extends between the plurality of wires to form an opening in the wire frame assembly when the arm member is moved to the release position. The wire frame assembly further includes an inner hub having at least one recess and an outer hub having an alignment slot. The alignment slot may be aligned with the at least one recess of the inner hub, such that at least one of the plurality of wires may be inserted through the alignment slot and into the at least one recess. Once the wire is positioned within the at least one recess, the outer hub may be rotated relative to the inner hub, such that the alignment slot rotates over the wire and causes the wire to deform. The deformation of the wire caused by rotation of the outer hub may act to lock the wire between the outer hub and the inner hub. Additional wires may be inserted and locked between the inner hub and the outer hub in a similar manner until each of the plurality of wires have been secured in the wire frame assembly. The disclosed item collection device and wire frame assembly allows for any of the plurality of wires to be replaced by simply rotating the outer hub relative to the inner hub and removing a damaged and/or worn wire from the assembly.

Further aspects of the embodiments described herein are provided by the subject matter of the following clauses:

Clause 1. An item collection device comprising: a handle; a wire frame assembly coupled to the handle, the wire frame assembly including a plurality of wires forming a basket-like structure; and an arm member hingedly coupled to the handle, the arm member being rotatable between a collection position and a release position and further including a protrusion positioned on a distal end of the arm member; wherein, when the arm member is rotated to the release position, the protrusion extends between the plurality of wires to form an opening in the wire frame assembly.

Clause 2. The item collection device of clause 1, further comprising a connector that is releasably attached to a first side of the wire frame assembly, a second side of the wire frame assembly, and the handle.

Clause 3. The item collection device of clauses 1 or 2, wherein the wire frame assembly further comprises: an inner hub having a plurality of recesses; and an outer hub coupled to the inner hub, the outer hub further including an alignment slot.

Clause 4. The item collection device of any of clauses 1-3, wherein the outer hub of the wire frame assembly is rotatable relative to the inner hub of the wire frame assembly between an unlocked position and a locked position.

Clause 5. The item collection device of any of clauses 1-4, wherein, in the unlocked position, the alignment slot aligns with at least one recess of the plurality of recesses to receive at least one end of at least one of the plurality of wires, and in the locked position, the outer hub is rotated such that the alignment slot is misaligned with the at least one recess of the plurality of recesses.

Clause 6. The item collection device of any of clauses 1-5, wherein each of the plurality of wires include at least one end having a non-linear profile.

Clause 7. The item collection device of any of clauses 1-6, wherein the wire frame assembly further includes a flange secured to the inner hub, the flange being configured to maintain the basket-like structure of the plurality of wires.

Clause 8. The item collection device of any of clauses 1-7, wherein the flange further includes a plurality of connecting members configured to be received by a plurality of cavities formed in a central portion of the inner hub.

Clause 9. The item collection device of any of clauses 1-8, further comprising a hub cap coupled to the outer hub, the hub cap being configured to restrict rotational movement of the outer hub relative to the inner hub.

Clause 10. The item collection device of any of clauses 1-9, wherein the hub cap further includes a projection that is received by the alignment slot of the outer hub when the hub cap is coupled to the outer hub.

Clause 11. A wire frame assembly comprising: an inner hub having at least one recess; an outer hub coupled to the inner hub, the outer hub further including an alignment slot; and at least one wire including at least one end having a non-linear profile; wherein the outer hub is rotatable relative to the inner hub between an unlocked position and a locked position, such that, in the unlocked position, the alignment slot aligns with the at least one recess and the at least one end of the at least one wire is positioned within the at least one recess, and in the locked position, the outer hub is rotated such that the alignment slot is misaligned with the at least one recess.

Clause 12. The wire frame assembly of clause 11, further comprising a flange secured to the inner hub, the flange being configured to reinforce the at least one wire.

Clause 13. The wire frame assembly of clauses 11 or 12, wherein the flange further includes a plurality of connecting members configured to be received by a plurality of cavities formed in a central portion of the inner hub.

Clause 14. The wire frame assembly of any of clauses 11-13, further comprising a hub cap coupled to the outer hub, the hub cap being configured to restrict rotational movement of the outer hub relative to the inner hub.

Clause 15. The wire frame assembly of any of clauses 11-14, wherein the hub cap further includes a projection that is received by the alignment slot of the outer hub when the hub cap is coupled to the outer hub.

Clause 16. The wire frame assembly of any of clauses 11-15, further comprising a plurality of fasteners that extend at least partially through the hub cap, the outer hub, and the inner hub when the hub cap is coupled to the outer hub.

Clause 17. The wire frame assembly of any of clauses 11-16, wherein the at least one recess includes a plurality of recesses and the at least one wire includes a plurality of wires, and each of the plurality of wires are received in at least one of the plurality of recesses.

Clause 18. The wire frame assembly of any of clauses 11-17, wherein the plurality of wires are spaced equidistantly about a circumference of the inner hub.

Clause 19. A method of assembling a wire frame assembly, the method comprising: rotatably coupling an inner hub having a plurality of recesses to an outer hub having an alignment slot; aligning the alignment slot of the outer hub with at least one of the plurality of recesses; inserting an end of a wire into the at least one of the plurality of recesses in alignment with the alignment slot, the end of the wire including a non-linear profile; and rotating the outer hub relative to the inner hub such that the alignment slot becomes misaligned with the at least one of the plurality of recesses that receives the end of the wire and the wire becomes locked between the inner hub and the outer hub.

Clause 20. The method of clause 19, further comprising: coupling a flange to the inner hub, the flange being configured to maintain a shape of the wire; coupling a hub cap to the outer hub; and inserting a plurality of fasteners at least partially through the hub cap, the outer hub, and the inner hub, such that rotation of the outer hub relative the inner hub is restricted.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An item collection device comprising:
a handle;
a wire frame assembly coupled to the handle, the wire frame assembly including a plurality of wires forming a basket-like structure; and
an arm member hingedly coupled to the handle, the arm member being rotatable between a collection position and a release position and further including a protrusion positioned on a distal end of the arm member;
wherein, when the arm member is rotated to the release position, the protrusion extends between the plurality of wires to form an opening in the wire frame assembly.

2. The item collection device of claim 1, further comprising a connector that is releasably attached to a first side of the wire frame assembly, a second side of the wire frame assembly, and the handle.

3. The item collection device of claim 1, wherein the wire frame assembly further comprises:
an inner hub having a plurality of recesses; and
an outer hub coupled to the inner hub, the outer hub further including an alignment slot.

4. The item collection device of claim 3, wherein the outer hub of the wire frame assembly is rotatable relative to the inner hub of the wire frame assembly between an unlocked position and a locked position.

5. The item collection device of claim 4, wherein, in the unlocked position, the alignment slot aligns with at least one recess of the plurality of recesses to receive at least one end of at least one of the plurality of wires, and in the locked position, the outer hub is rotated such that the alignment slot is misaligned with the at least one recess of the plurality of recesses.

6. The item collection device of claim 1, wherein each of the plurality of wires include at least one end having a non-linear profile.

7. The item collection device of claim 3, wherein the wire frame assembly further includes a flange secured to the inner hub, the flange being configured to maintain the basket-like structure of the plurality of wires.

8. The item collection device of claim 7, wherein the flange further includes a plurality of connecting members configured to be received by a plurality of cavities formed in a central portion of the inner hub.

9. The item collection device of claim 3, further comprising a hub cap coupled to the outer hub, the hub cap being configured to restrict rotational movement of the outer hub relative to the inner hub.

10. The item collection device of claim 9, wherein the hub cap further includes a projection that is received by the alignment slot of the outer hub when the hub cap is coupled to the outer hub.

11. A wire frame assembly comprising:
an inner hub having at least one recess;
an outer hub coupled to the inner hub, the outer hub further including an alignment slot; and
at least one wire including at least one end having a non-linear profile;
wherein the outer hub is rotatable relative to the inner hub between an unlocked position and a locked position, such that, in the unlocked position, the alignment slot aligns with the at least one recess and the at least one end of the at least one wire is positioned within the at least one recess, and in the locked position, the outer hub is rotated such that the alignment slot is misaligned with the at least one recess.

12. The wire frame assembly of claim 11, further comprising a flange secured to the inner hub, the flange being configured to reinforce the at least one wire.

13. The wire frame assembly of claim 12, wherein the flange further includes a plurality of connecting members configured to be received by a plurality of cavities formed in a central portion of the inner hub.

14. The wire frame assembly of claim 11, further comprising a hub cap coupled to the outer hub, the hub cap being configured to restrict rotational movement of the outer hub relative to the inner hub.

15. The wire frame assembly of claim 14, wherein the hub cap further includes a projection that is received by the alignment slot of the outer hub when the hub cap is coupled to the outer hub.

16. The wire frame assembly of claim 15, further comprising a plurality of fasteners that extend at least partially through the hub cap, the outer hub, and the inner hub when the hub cap is coupled to the outer hub.

17. The wire frame assembly of claim 11, wherein the at least one recess includes a plurality of recesses and the at least one wire includes a plurality of wires, and each of the plurality of wires are received in at least one of the plurality of recesses.

18. The wire frame assembly of claim 17, wherein the plurality of wires are spaced equidistantly about a circumference of the inner hub.

19. A method of assembling a wire frame assembly, the method comprising:
rotatably coupling an inner hub having a plurality of recesses to an outer hub having an alignment slot;
aligning the alignment slot of the outer hub with at least one of the plurality of recesses;
inserting an end of a wire into the at least one of the plurality of recesses in alignment with the alignment slot, the end of the wire including a non-linear profile; and
rotating the outer hub relative to the inner hub such that the alignment slot becomes misaligned with the at least one of the plurality of recesses that receives the end of the wire and the wire becomes locked between the inner hub and the outer hub.

20. The method of claim 19, further comprising:
coupling a flange to the inner hub, the flange being configured to maintain a shape of the wire;
coupling a hub cap to the outer hub; and
inserting a plurality of fasteners at least partially through the hub cap, the outer hub, and the inner hub, such that rotation of the outer hub relative the inner hub is restricted.
